(19) United States
(12) Patent Application Publication
(10) Pub. No.: US 2008/0276467 A1
(43) Pub. Date: Nov. 13, 2008

(54) Cutting apparatus

(76) Inventor: Jordan Schmidt, Westwood, NJ (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/801,590

(22) Filed: May 10, 2007

(51) Int. Cl. B26B 9/02; B26B 3/03

(52) U.S. Cl. 30/340; 30/353

(57) ABSTRACT

The cutting apparatus includes a blade with a cutting edge. The blade includes at least two blade elements integrated in a surface of a first face of the blade, and adjacent elements are configured so as to overlap each other for a pre-determined area having a longitudinal axis substantially perpendicular to a line tangential to the cutting edge.

### BACKGROUND

1. Technical Field

The present invention relates to a cutting apparatus, and more particularly, to a knife blade assembly configured for facilitating cutting, particularly of food products.

2. Description of Related Art

Knives for cutting and slicing food products into slices are well-known in the art and may include an array of blade and edge designs configured with various means for facilitating cutting action.

During a cutting operation with a knife, each lateral side of the knife blade is caused to be slid through an object, generating a frictional force and thus reducing cutting speed and efficiency. Various attempts have been made to remedy this problem. For example, the prior art of knife assemblies includes knives having recesses distributed along at least one lateral side of a rigid blade member.

However, while such designs incorporating recesses distributed on a knife blade may assist in reducing drag during use, it is highly desirable to further optimize efficiency during cutting.

Accordingly, an improved cutting apparatus which optimizes cutting action by minimizing excess drag and frictional resistance/torsional force is highly desirable.

### SUMMARY

Advantageously, the configuration and arrangement of a cutting apparatus according to the present principles provides reduction in drag and reduced frictional resistance during cutting, allowing the apparatus to be passed through objects with improved efficiency and smoother action. For example, as the blade is passed through an object in a downwards motion, at least two adjacent, overlapping blade elements on at least one blade face are caused to be passed through the object simultaneously. Blade surface area contact with the object being cut is thus effectively minimized, reducing friction and improving cutting action.

According to a first aspect, a cutting apparatus is provided including a blade having a cutting edge. The blade includes at least two blade elements integrated in a surface of a first face of the blade, and adjacent elements are configured so as to overlap each other for a pre-determined area having a longitudinal axis substantially perpendicular to a line tangential to the cutting edge.

According to another aspect, a knife is provided having a handle and a blade affixed at a first end of the handle. The blade has a cutting edge and includes at least two blade elements integrated in a surface of a first face of the blade, wherein adjacent elements are configured so as to overlap each other for a pre-determined area having a longitudinal axis substantially perpendicular to a line tangential to the cutting edge.

These and other aspects, features, and advantages of the present principles will be described or become apparent from the following detailed description of the preferred embodiments, which is to be read in connection with the accompanying drawings.

### BRIEF DESCRIPTION OF THE DRAWINGS

This disclosure will present in detail the following description of preferred embodiments with reference to the following figures wherein:

FIG. 1 is a perspective representation of a knife assembly according to one embodiment of the present principles;

FIG. 2 is an exemplary side view of the knife assembly of FIG. 1 according to one embodiment of the present principles;

FIG. 3 is a perspective representation of a knife assembly according to one embodiment of the present principles;

FIG. 4 is an exemplary side view of the knife assembly of FIG. 3 according to one embodiment of the present principles;

FIG. 5 is an exemplary cross-sectional view taken along line A-A of FIG. 4 according to one embodiment of the present principles; and

FIG. 6 is an exemplary cross-sectional view taken along line A-A of FIG. 4 according to an alternate embodiment.

### DETAILED DESCRIPTION

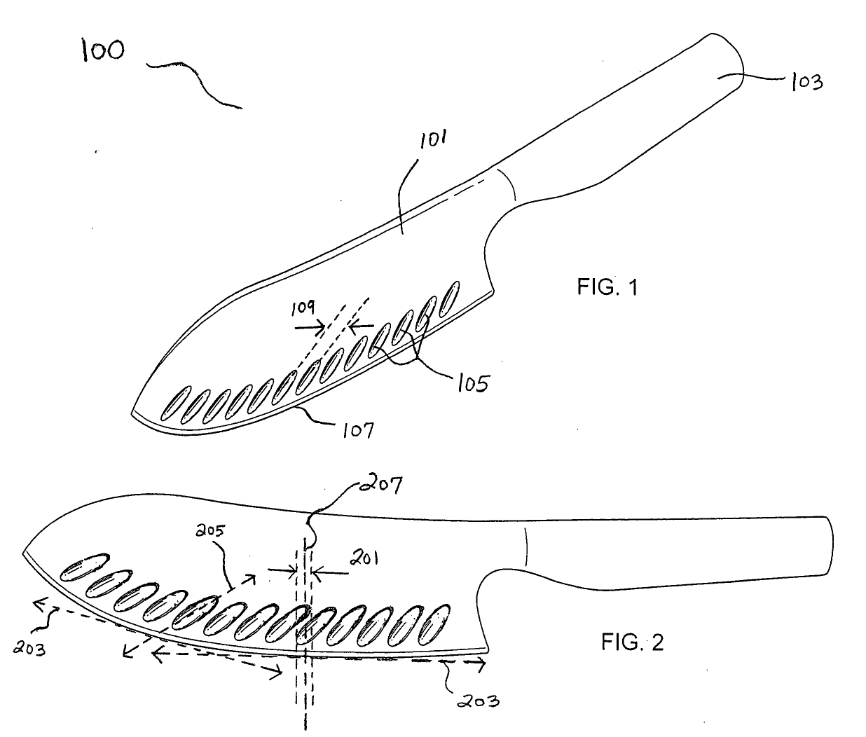

Referring now to the Figures, FIGS. 1 and 2 depict a first embodiment of a knife assembly 100 for cutting objects, for example, food products. The knife assembly 100 includes a blade 101 having a handle 103 affixed at one end and a cutting edge 107 disposed longitudinally along a bottom end thereof. The handle 103 may comprise a separate attachment or be integrally formed with the blade 101. Preferred materials from which the blade may be comprised preferably include abrasion resistant stainless steel such as high carbon steel and various steel/carbon alloys including alternative alloys incorporating ceramic, titanium, silver, etc.

At least one face of the blade 101 includes at least two, but preferably a plurality of blade elements 105 integrated therein and distributed proximate to the cutting edge 107. Each blade element 105 may comprise, e.g., a recess, for example a tapered hollow or indent, or a protrusion (e.g., a convex protruding element). The plurality of blade elements 105 may comprise any combination, arrangement or pattern of recesses and/or protrusions. Those of skill in the art will appreciate that in other implementations, the blade elements 105 may comprise any shape, e.g., square, rectangular, polygonal, circular, oval, elliptical, etc., and can have a vary in length and/or depth. By way of example, the length of the blade elements can be in a range of 0.1 inches to 2+ inches. In other examples, the depth of the blade elements can be in a range of 0.01 inches to 0.15 inches. The depth of the blade element can be changed depending on the thickness of the overall knife blade, and can clearly be outside this preferred range.

Any number of blade elements 105 may be provided on the blade face 101, each preferably disposed longitudinally in a row parallel and proximate to the cutting edge 107. While the blade elements 105 may be arranged with any amount of spacing 109 therebetween, in a preferred embodiment the elements 105 are distributed at a substantially equidistant spacing 109 from each other.

In one exemplary embodiment, the elements 105 are distributed in at least one row along edge 107, with each element 105 comprising an elongate oval or elliptical shape. According to one aspect, adjacent elements 105 are oriented so as to overlap each other for a pre-determined area 201. In one example, the overlap area 201 includes a longitudinal axis 207 (running parallel thereto) which is substantially perpendicular to a line 203 tangential to cutting edge 107. Overlap area 201 may be any distance, but in an exemplary embodiment is, for example, at least about one-third the length of each element 105. In another exemplary embodiment, the elements 105 are oriented at a slant such that a longitudinal axis 205 of each element 105 is at a substantially non-orthogonal angle relative to a tangential line 203 at the point of intersection of the longitudinal axis with edge 107.

Elements 105 may also be provided on the opposite side of the blade 101, such that the knife 100 includes a blade 101 having elements 105 distributed along both sides proximate to edge 107 and configured to overlap for a predetermined area having a longitudinal axis substantially perpendicular to a line tangential to the cutting edge 107. The elements 105 on one side may be provided at a same or different slant with respect to elements 105 along the opposite side of the blade 101. The elements 105 may also be provided in a ‘staggered’ arrangement with respect to elements 105 along the opposite side of blade 101, e.g., with a spacing 109 on one side of blade 101 directly corresponding to a element 105 on the opposing side of blade 101.

Advantageously, the configuration and arrangement of elements 105 including the overlap 201 of each adjacent element 105 provides reduction in drag and frictional resistance during cutting, allowing the knife 100 to be passed through objects with improved efficiency and smoother cutting action. For example, as the blade 101 is passed through an object in a downwards motion, at least two adjacent, overlapping elements 105 on at least one blade face 101 are caused to be passed through the object simultaneously. Blade surface area contact with the object being cut is thus effectively reduced, resulting in an improved reduced-friction cutting action.

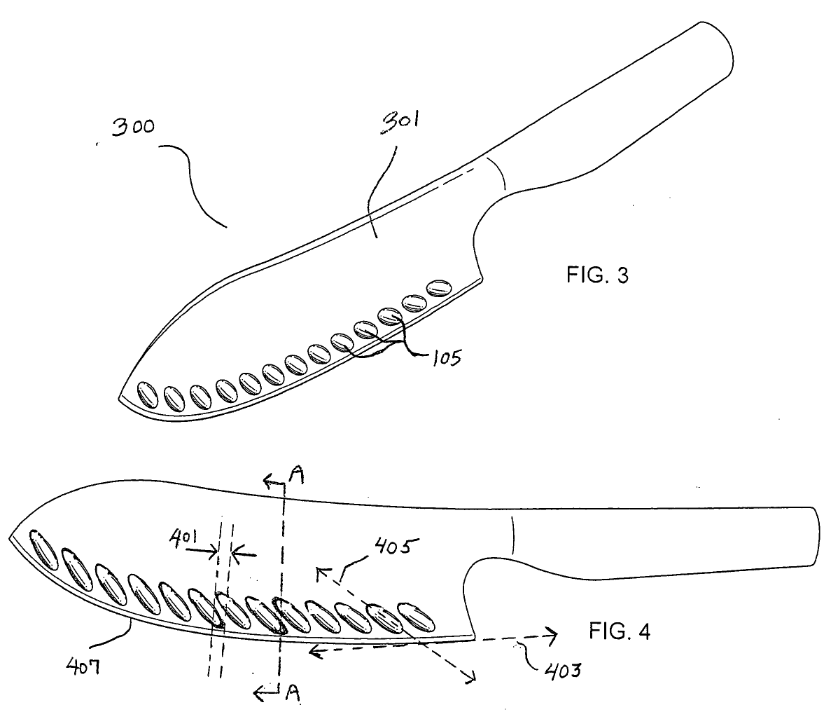

Referring to FIGS. 3 and 4 a second embodiment of knife assembly 100 for cutting objects, for instance such as food products, is shown. FIG. 3 is a perspective representation of a knife assembly according to one embodiment of the present principles and FIG. 4 is an exemplary side view of the knife assembly of FIG. 3. In this embodiment, elements 105 are arranged at a slanted direction 405 opposite to the slant shown in FIGS. 1 and 2. Preferably, the elements 105 are oriented at a slant such that a longitudinal axis 405 of each element 105 is at a substantially non-orthogonal angle relative to a line 403 tangential to the point of intersection of axis 405 with cutting edge 407.

Elements 105 may also be provided on the opposite side of the blade 301, such that the knife 300 includes a blade 301 having elements 105 distributed along both sides proximate to edge 407. The elements 105 on one side may be provided at a same or different slant with respect to elements 105 along the opposite side of the blade 301. The elements 105 on one side may be provided in a ‘staggered’ arrangement with respect to elements 105 along the opposite side of blade 301, as described above.

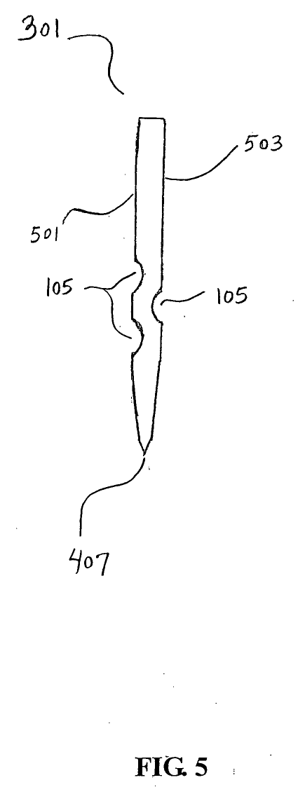

FIG. 5 is an exemplary cross-sectional view of blade 301 taken along line A-A of FIG. 4. FIG. 5 depicts a cross-sectional view of a blade having an exemplary ‘staggered’ arrangement of elements 105 on opposing sides. According to one aspect, a first blade face 501 includes at least two elements 105 in the cross-sectional view A-A, wherein each element 105 includes an overlapping portion and the elements 105 are aligned so as to each have an overlapping portion lying directly on top of one another.

An opposing blade face 503 includes at least one element 105 preferably situated to have at least a portion of the element 105 lying in an area which does not include an element 105 on the first side 501. Here, for example, the element 105 on second face 503 is situated in between the upper and lower elements 105 on the first face 501. The sidewalls of blade 301 taper thinner towards cutting edge 407.

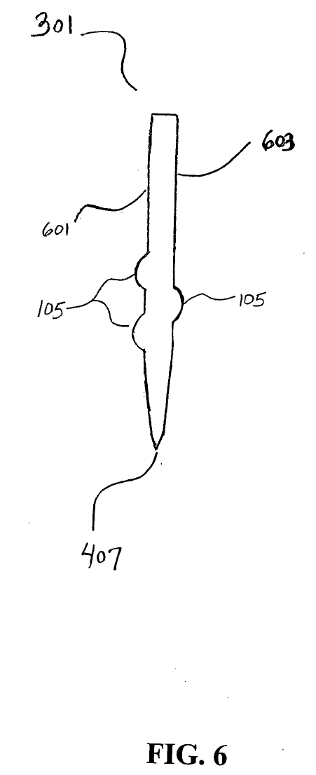

FIG. 6 is an exemplary cross-sectional view of blade 301 taken along line A-A of FIG. 4 according to an exemplary alternate embodiment. In this embodiment, e.g., the blade elements 105 comprise a plurality of convex protrusions, which here, are distributed on opposing sides 601, 603 of blade 301 in a ‘staggered’ arrangement, e.g., as described above with reference to FIG. 5.

The knife assembly 100, 300 according to the present principles, possesses the advantage of improved efficiency during use by reducing drag and frictional resistance during cutting, thus increasing its ease of use, efficiency and practicality.

While there have been shown, described and pointed out fundamental novel features of the present principles, it will be understood that various omissions, substitutions and changes in the form and details of the methods described and devices illustrated, and in their operation, may be made by those skilled in the art without departing from the spirit of the same. For example, it is expressly intended that all combinations of those elements and/or method steps which perform substantially the same function in substantially the same way to achieve the same results are within the scope of the present principles. Moreover, it should be recognized that structures and/or elements and/or method steps shown and/or described in connection with any disclosed form or implementation of the present principles may be incorporated in any other disclosed, described or suggested form or implementation as a general matter of design choice. It is the intention, therefore, to be limited only as indicated by the scope of the claims appended hereto

What is claimed is:

1. A cutting apparatus comprising:
a blade having a cutting edge, the blade including at least two blade elements integrated in a surface of a first face of the blade, wherein adjacent elements are configured so as to overlap each other for a pre-determined area having a longitudinal axis substantially perpendicular to a line tangential to the cutting edge.

2. The apparatus of claim 1, wherein the blade includes at least a row of elements distributed proximate to the cutting edge.

3. The apparatus of claim 1, wherein each element comprises a recess.

4. The apparatus of claim 2, wherein the elements are configured to be substantially equidistant from each other.

5. The apparatus of claim 1, wherein each element is oriented at a slant, such that a longitudinal axis of each element is at a substantially non-orthogonal angle relative to the tangential line at the point of intersection of each longitudinal axis with the cutting edge.

6. The apparatus of claim 1, further comprising at least two elements integrated on a second face of the blade, wherein adjacent elements of said at least two elements are configured so as to overlap each other for a pre-determined area having a longitudinal axis substantially perpendicular to a line tangential to the cutting edge.

7. The apparatus of claim 6, wherein the elements on the second face of the blade are configured in a staggered arrangement with respect to the elements provided on the first side of the blade.

8. The apparatus of claim 6, wherein each element on the second face is oriented at a slant, such that a longitudinal axis of each element is at a substantially non-orthogonal angle relative to the tangential line at the point of intersection of each longitudinal axis with the cutting edge.

9. The apparatus of claim 8, wherein the slant of the elements on the second face is in an opposite direction to a slant of the elements on the first face of the blade.

10. The apparatus of claim 1, wherein each blade element comprises a protrusion.

11. A knife comprising:
a handle; and
a blade affixed at a first end of the handle, the blade having a cutting edge and including at least two blade elements integrated in a surface of a first face of the blade, wherein adjacent elements are configured so as to overlap each other for a pre-determined area having a longitudinal axis substantially perpendicular to a line tangential to the cutting edge.

12. The knife of claim 11, wherein the blade includes at least a row of elements disposed longitudinally proximate and parallel to the cutting edge.

13. The knife of claim 11, wherein each element comprises a recess.

14. The knife of claim 12, wherein the elements are configured to be substantially equidistant from each other on the blade surface.

15. The knife of claim 11, wherein each element is oriented at a slant, such that a longitudinal axis of each element is at a substantially non-orthogonal angle relative to the tangential line at the point of intersection of each longitudinal axis with the cutting edge.

16. The knife of claim 11, further comprising at least two elements integrated onto a second face of the blade, wherein adjacent elements are configured so as to overlap each other for a pre-determined area having a longitudinal axis substantially perpendicular to a line tangential to the cutting edge.

17. The knife of claim 16, wherein the elements on the second face of the blade are configured in a staggered arrangement with respect to the elements provided on the first side of the blade.

18. The knife of claim 16, wherein each element on the second face is oriented at a slant, such that a longitudinal axis of each element is at a substantially non-orthogonal angle relative to the tangential line at the point of intersection of each longitudinal axis with the cutting edge.

19. The knife of claim 18, wherein the slant of the elements on the second face is in an opposite direction to a slant of the elements on the first face of the blade.

20. The knife of claim 11, wherein each element comprises a protrusion.
